(19) United States
(12) Patent Application Publication
(10) Pub. No.: US 2010/0057498 A1
(43) Pub. Date: Mar. 4, 2010

(54) METHOD AND COMPUTER SYSTEM FOR INSURANCE CLAIMS RECOVERY OPERATION

(76) Inventors: Gary D. Stephen, Canton, CT (US); Nancy L. Huff, Noblesville, IN (US); Ralph Steven Bush, Orlando, FL (US); Susan M. Kucia, Eustis, FL (US); Hans Peter Kingenberg, Minneola, FL (US)

Correspondence Address: BUCKLEY, MASCHOFF & TALWALKAR LLC, 50 LOCUST AVENUE, NEW CANAAN, CT, 06840, US

(21) Appl. No.: 12/204,325

(22) Filed: Sep. 4, 2008

(51) Int. Cl. G06Q 40/00

(52) U.S. Cl. 705/4

(57) ABSTRACT

A method includes receiving in a computer an electronic file that represents a claim paid by an insurance company. The electronic file indicates whether the claim involves another insurance company, and whether the other company has admitted or is likely to admit liability for the claim. The computer makes a triage decision to send a demand letter to the other company and then defer action if the other insurance company is likely to admit or has admitted liability. Otherwise, the computer sends the demand letter and routes the file for immediate follow-up.

### FIELD

The present invention relates to computer systems and more particularly to computer systems that manage workflow.

### BACKGROUND

After an insurance company has paid a claim from a policy holder, it is often the case that the insurance company has a right to recover some or all of the amount paid from a third party. For example, if the claim arose from a motor vehicle accident, the insurance company may have a right to pursue recovery against the driver of another vehicle involved in the accident. Typically, the other driver may also be covered by insurance, and the first insurance company may pursue its claim for recovery against the other insurance company.

For a large insurance company that pays a large number of claims, its operation for pursuing recovery from other insurance companies may also be large. Moreover, the process for pursuing recovery may be complex and may potentially involve numerous steps. The present inventors have studied a large and complex recovery operation and have arrived at certain techniques that may significantly improve the efficiency of an insurance company recovery operation.

### SUMMARY

A method provided in accordance with aspects of the present invention includes receiving in a computer an electronic file that represents a claim paid by an insurance company. The electronic file contains indicia as to (a) whether the claim involves another insurance company and (b) whether the other insurance company has admitted or is likely to admit liability for the claim.

The method also includes making a triage decision in the computer. The triage decision is such that (i) if the indicia indicate that another insurance company is involved and has admitted or is likely to admit liability for the claim, the computer sends out a demand letter to the other insurance company with respect to the claim and defers further action relating to the demand for at least 20 days; and (ii) if the indicia either do not indicate that another insurance company is involved or indicate that the other insurance company has not admitted or is not likely to admit liability for the claim, the computer sends out a demand letter to the other insurance company and routes the electronic file to an employee for further action.

According to teachings of the present invention, employee involvement is deferred in claim files which are likely to result in payment of the demanded recovery in due course by the other insurance company. The period of deferral may be selected to reflect probable processing times by other insurance companies. Thus employee time and effort are not expended on files which are likely to come to a successful conclusion without employee involvement. The savings in employee time and effort may be re-directed to work on more difficult recovery efforts. These techniques may lead to increased efficiency and improved results for the insurance company's recovery operation.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram of a system provided according to aspects of the present invention.

FIG. 2 is a block diagram representation of a triage/workflow routing computer shown as part of the system of FIG. 1.

FIG. 3 is a flow chart that illustrates a process that may be implemented in accordance with aspects of the present invention in the triage/workflow routing computer of FIG. 2.

FIGS. 4A and 4B together form a flow chart that illustrates further details that may be incorporated in the process of FIG. 3.

### DETAILED DESCRIPTION

In general, and for the purposes of introducing concepts of embodiments of the present invention, claim files received in a claim recovery office are triaged to determine what steps should be taken with respect to the claim files. The claim files may be received in electronic form and input into a triage/workflow routing computer that is to make the triage determinations. The triage/workflow routing computer may review each claim file to determine whether another, potentially liable insurance company has been identified. Further, the triage/workflow routing computer may determine whether the other insurance company has admitted or is likely to admit liability. If so, the triage/workflow routing computer may send out a demand letter to the other insurance company, and then cause further activity to be deferred for a period of time that is likely to be long enough for the other insurance company to process the demand and make payment. In circumstances studied by the present inventors, the optimal period of time for deferring such claims was found to be 43 days. With this deferral of activity after sending the demand package, no employee time and effort is expended with respect to demands for recovery that are not likely to require employee time and effort. The triage/workflow routing computer also sends out demand letters for other claim files (i.e., those in which the other company is likely to contest liability), but the latter files are promptly routed to a claim handler for follow up with the other insurance company within a few days after the other insurance company receives the demand letter. In this way, the files that are likely to require negotiation are moved forward for action as soon as possible, and employee efforts are concentrated on contested files, where their efforts are likely to produce the greatest benefit.

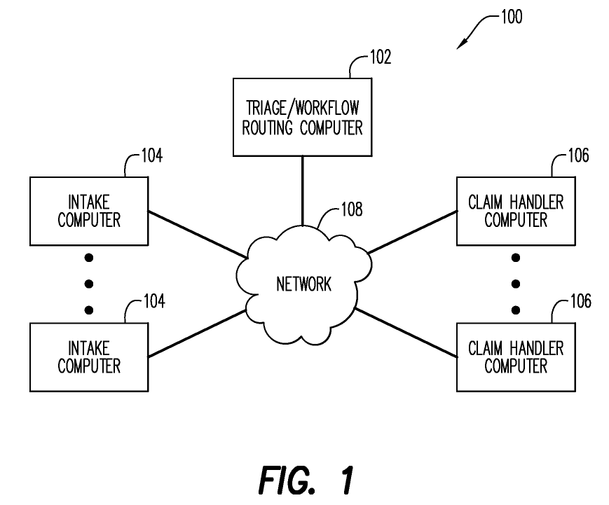

FIG. 1 is a block diagram of a system 100 provided according to aspects of the present invention. The system 100 may be operated by an insurance company. The system 100 includes a triage/workflow routing computer 102 that is described in more detail below and may be operated by a claim recovery office of the insurance company.

The system 100 further includes a number of intake computers 104 that are operated by employees of the insurance company for purposes of inputting and gathering information to be incorporated in electronic claim files to be submitted to the triage/workflow routing computer 102. Still further, the system 100 may also include a number of computers 106 that are operated with employees of the claim recovery office such as claim handlers who are responsible for moving files forward toward recovery of amounts paid or other resolution of the files.

A further component of the system 100 is a data network 108. The data network 108 may include, for example, an intranet operated by the insurance company and interconnecting the computers 102, 104 and 106 to permit exchanging of data among those computers. The system 100 may further include an electronic mail server (not shown) which may also be coupled to the data network 108 to facilitate the transmission of electronic messages among the computers 102, 104 and 106.

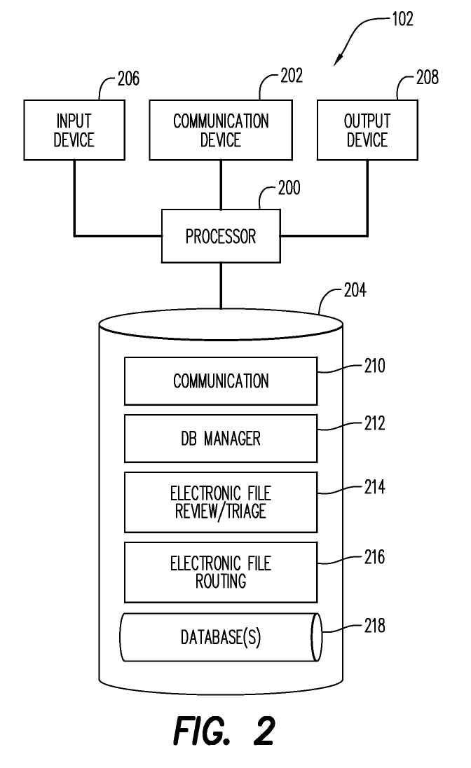

FIG. 2 is a block diagram that illustrates an example embodiment of the triage/workflow routing computer 102. In its hardware aspects the triage/workflow routing computer 102 may be entirely conventional, but may be programmed to operate in accordance with aspects of the present invention. In a practical embodiment, the triage/workflow routing computer 102 may be constituted by a conventional personal computer or server computer programmed by software that implements functionality as described herein.

As depicted, the triage/workflow routing computer 102 includes a computer processor 200 operatively coupled to, and in communication with, a communication device 202, a storage device 204, one or more input devices 206 and one or more output devices 208. Communication device 202 may be used to facilitate communication with, for example, other devices such as the computers 104 and 106. The input device(s) 206 may comprise, for example, a keyboard, a keypad, a mouse or other pointing device, a scanner, a microphone, knob or a switch, an infra-red (IR) port, a docking station, and/or a touch screen. The input device(s) 206 may be used, for example, to enter information such as input from a user of the triage/workflow routing computer 102. Output device 208 may comprise, for example, a display (e.g., a display screen), a speaker, and/or a printer.

Storage device 204 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. As used herein and in the appended claims, a “memory” refers to any one or more of the components of the storage device 204, including removable storage media.

Storage device 204 stores one or more programs for controlling processor 200. Processor 200 performs instructions of the programs, and thereby operates in accordance with the present invention. In some embodiments, the programs may include a program 210 that controls the processor 200 to allow for data communication between the triage/workflow routing computer 102 and other devices. The programs may also include one or more conventional database manager programs, indicated at 212.

Still further, the programs may include an application program 214 that controls the triage/workflow routing computer 102 to review electronic claim files and to automatically make triage decisions with respect to the electronic claim files. In addition, a program or program module 216 may be stored in the storage device 204 for the purpose of controlling the triage/workflow routing computer 102 to implement its triage decisions by routing the electronic claim files to other computers as appropriate.

There may also be stored in the storage device 204 other software, such as one or more conventional operating systems, device drivers, etc.

Still further, the storage device 204 may store one or more databases 218. The databases 218 may include, for example, electronic claims files for which the triage/workflow routing computer 102 has sent out demand letters and as to which the triage/workflow routing computer 102 is deferring further activity, as called for by certain aspects of the present invention.

The other components of the system 100, including for example computers 104 and 106 and data network 108, may be conventional, at least with respect to their hardware aspects. The computers 104 and 106, for example, may be constituted by conventional personal computers and thus may be formed of components and a hardware architecture such as those described above in connection with the triage/workflow routing computer 102.

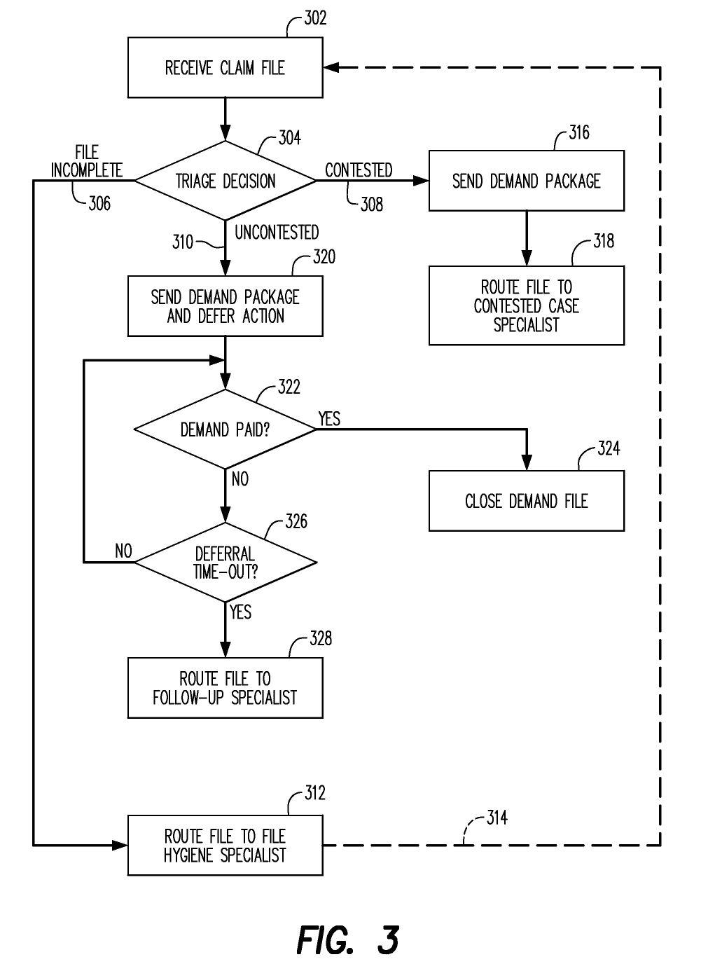

FIG. 3 is a flow chart that illustrates a process that may be implemented in accordance with aspects of the present invention in the triage/workflow routing computer 102.

At 302, the triage/workflow routing computer 102 receives an electronic file that represents a claim that has been paid by the insurance company. For purposes of the ensuing description of this example embodiment of the invention, it will now be assumed that the claim relates to a multi-vehicle traffic accident. The electronic file may include conventional elements such as a police report, photographs of the damage sustained by the insured vehicle, an appraisal of the cost of repairing the insured vehicle, a chronology of the activities of the insurance company with respect to the file, including payment of the claim, the names and addresses of the owners of the vehicles, the name and contact information (if available) of one or more other insurance companies involved in the claim. In some embodiments, the electronic claim file may include data entered by an employee of the insurance company concerning the claim in question. In some embodiments, the data entered by the insurance company employee may include one or more codes concerning the claim file. Any or all of the information in the claim file may be considered indicia that indicate attributes of the claim file.

Decision block 304 follows 302 in the process of FIG. 3. At 304, the triage/workflow routing computer 102 makes a triage decision with respect to the electronic claim file received at 302. In the example embodiment disclosed herein, the triage decision may have any one of the following three outcomes: (1) A finding 306 that the electronic claim file is incomplete; (2) a finding 308 that the other insurance company has contested or is likely to contest liability for the claim; and (3) a finding 310 that the other insurance company has not or likely will not contest liability for the claim. The latter finding may be considered equivalent to a finding that the other insurance company has admitted or is likely to admit liability for the claim.

In the case of the finding 306 that the electronic claim file is incomplete, the process of FIG. 3 advances from decision block 304 to block 312. At 312, the triage/workflow routing computer 102 routes the electronic claim file to the computer of a suitable employee of the insurance company who is responsible for obtaining information necessary to complete the electronic claim file. Once that has been done, the electronic claim file may be routed back to the triage/workflow routing computer 102, as suggested by dashed arrow path 314, at which point steps 302 and 304 may be repeated.

In the case of the finding 308 that the other insurance company has contested liability or is likely to do so, the process of FIG. 3 advances from decision block 304 to 316. At 316, the triage/workflow routing computer 102 draws on information from the electronic claim file to put together a demand package that the triage/workflow routing computer 102 automatically causes to be sent to the other insurance company. The demand package may be conventional in nature, and may include information commonly included in a demand package such as a cover letter (demand letter), documents supporting the insurance company's position that the other insurance company is liable, documentation of the amount paid on the claim by the insurance company that operates the triage/workflow routing computer 102, etc. For example, in addition to the demand letter, the demand package may include the police report for the accident, color photographs of the damage to the insured vehicle, the insurance company's payment ledger, the appraisal for the property damage to the vehicle, and the bill for the insured's rental of another vehicle. The triage/workflow routing computer 102 may send the demand package to the other insurance company by mail or courier in hard copy form, and/or the triage/workflow routing computer 102 may send the demand package to the other insurance company electronically by a set of facilities put in place for that purpose by a community of insurance companies, or by ordinary electronic mail.

In the process of FIG. 3, step 318 follows step 316. At step 318 the triage/workflow routing computer 102 may route the electronic claim file received at 302 to an employee of the insurance company in the claim recovery office. This may be done, for example, by sending the electronic claim file to the employee's computer via electronic mail in the system 100. The employee in question may be a claim handler who is experienced in negotiating contested claims with other insurance companies. The triage/workflow routing computer 102 may route the electronic claim file to the claim handler with an automatic reminder for the claim handler to contact the other insurance company within a fairly short period of time, say within 7 to 10 days or less. The timing of the reminder may be such that the claim handler contacts the other insurance company within a few days after the other insurance company receives the demand package. If the demand package is sent to the other insurance company by electronic mail, the timing of the reminder may prompt the claim handler to contact the other insurance company within one to three days after the triage/workflow routing computer 102 sends the demand package to the other insurance company.

This procedure, including a follow-up contact to the other insurance company shortly after the other insurance company receives the demand package, may put all issues related to the claim on a path for prompt resolution with the other insurance company, with little or no unnecessary delay in moving the case forward.

The triage/workflow routing computer 102 may make the finding 310 that liability is or likely will be uncontested by the other insurance company in the following three circumstances, according to one embodiment of the invention—First, if the other insurance company has explicitly admitted liability according to information contained in the electronic claim file; second, if the insured vehicle was parked at the time of the collision; or third, if the insured vehicle was rear-ended. In all other cases in which the electronic file is found to be complete, the triage/workflow routing computer 102 may make the finding 308 that the claim is or is likely to be contested by the other insurance company.

In the case of the finding 310 that the other insurance company has admitted liability or is likely to do so, the process of FIG. 3 advances from decision block 304 to 320. At 320, the triage/workflow routing computer 102 sends the demand package to the other insurance company, in the manner described above in connection with step 316. However, in some embodiments, rather than routing the electronic claim file for further action, the triage/workflow routing computer 102 defers further activity on the claim file relative to the other insurance company for a predetermined period of time. In certain circumstances, the present inventors have found that an optimal period for deferral is 43 days. The present inventors have found that a deferral period of this length allows for payment to be received from the other insurance company in the vast majority of cases in which admission of liability by the other insurance company is anticipated, and without any expenditure of employee time and effort on the part of the demanding insurance company vis a vis contacting the other insurance company. In other circumstances, or in future systems that may arise, the optimal deferral period may be shorter or longer than 43 days. For example, it is believed that a deferral period of at least 20 days is likely always to be advisable for claims in which the other insurance company is expected to admit liability. Other possibly desirable lengths of the deferral period may be 30 days or 40 days.

(In some alternative embodiments, the triage/workflow routing computer 102 may implement deferral of further activity on the claim, as called for by step 320, by routing the electronic claim file to an insurance company employee in the claim recovery office, but with a direction to hold off on following up on the demand with the other insurance company until the deferral period has elapsed.)

Following step 320 in FIG. 3 is decision block 322. At decision block 322, the triage/workflow routing computer 102 periodically (e.g., daily after a certain number of days has elapsed after step 320) checks to determine whether the other insurance company has paid the amount demanded at step 320. If so, step 324 follows, at which the triage/workflow routing computer 102 closes the case file. However, if a negative determination is made at 322 (i.e., if the triage/workflow routing computer 102 determines at 322 that the other insurance company has not paid the amount demanded), then the process of FIG. 3 advances from decision block 322 to decision block 326. At decision block 326, the triage/workflow routing computer 102 determines whether the end of the deferral period has been reached. If not, the process loops back to decision block 322. Thus, the process of FIG. 3 may remain in the loop formed by decision blocks 322 and 326 until either the other insurance company pays the demand, or the deferral period runs out.

If the deferral period runs out without payment having been received, then the triage/workflow routing computer 102 so determines at decision block 326, and the process of FIG. 3 advances from decision block 326 to step 328. At step 328, the triage/workflow routing computer 102 routes the electronic claim file to a suitable employee of the insurance company in the claim recovery office. The employee who receives the electronic file at step 328 need not necessarily be an experienced claim handler. For example, the employee in this case may be an administrative employee who follows up with the other insurance company to determine why the other insurance company did not pay the demand. If it turns out that the other insurance company in fact is contesting liability, then the administrative employee may refer the case to a claim handler of the type who receives claim files in connection with step 318. Otherwise, for example if there is some administrative issue or the like that has impeded payment of the demand, then the administrative employee may continue to follow up with the other insurance company until the demand is paid.

In some embodiments, the triage/workflow routing computer 102 may operate to automatically obtain at least some attachments included with the demand package. Such items may include, for example, one or more of (a) a police report; (b) at least one color photograph of a damaged vehicle; (c) at least one color photograph of a motor vehicle accident scene; (d) a payment ledger; (e) a vehicle damage appraisal; and (f) a replacement vehicle rental bill. The triage/workflow routing computer 102 may obtain these items from external sources such as a database of police reports or another computer operated by or on behalf of the insurance company that paid the claim.

In some embodiments, the deferral period—during which the triage/workflow routing computer 102 defers action on claims that the other company is expected to admit liability for—may vary with changing conditions. For example, the deferral period may be adjusted in length from time to time based on past history in receipt of payment for uncontested claims, or based on various optimization techniques.

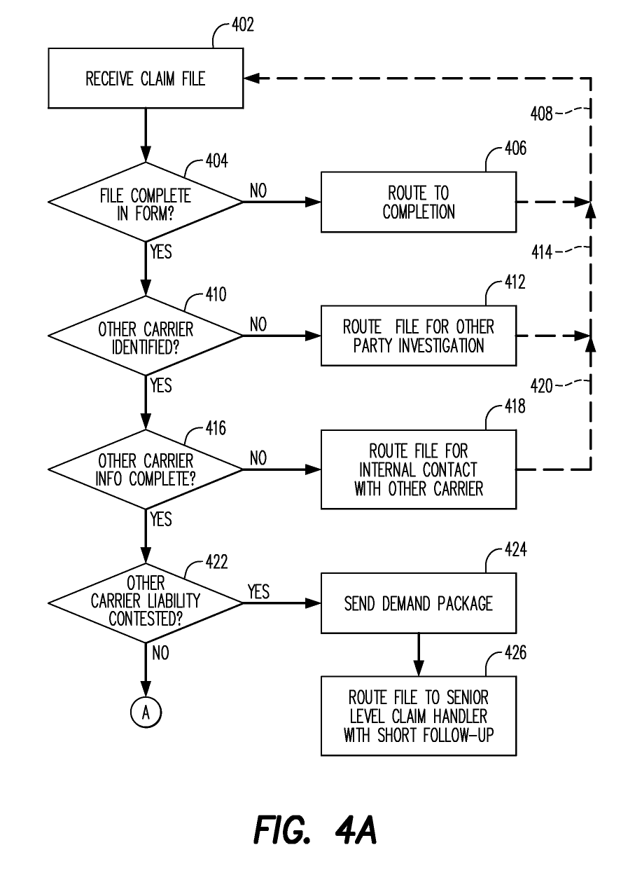

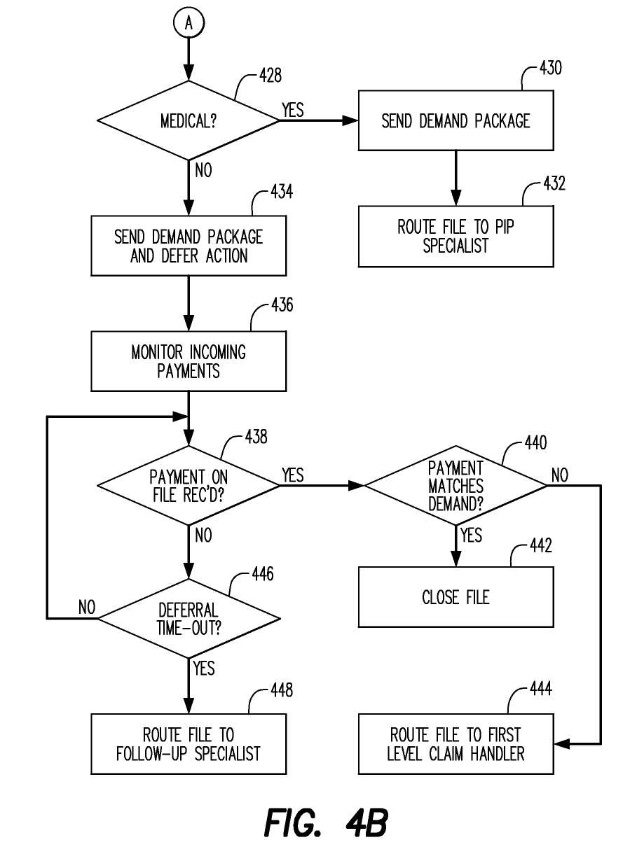

FIGS. 4A and 4B together form a flow chart that illustrates further details that may be incorporated in the process of FIG. 3.

As in the process of FIG. 3, the process of FIGS. 4A-4B begins with the triage/workflow routing computer 102 receiving an electronic file that represents a claim that has been paid by the insurance company (step 402). For purposes of this example embodiment, it will again be assumed that the claim arises from a multi-vehicle traffic accident. In this example as well, the electronic claim file may be as it was described above in connection with step 302 in FIG. 3.

Continuing to refer to FIG. 4A, decision block 404 follows 402. At decision block 404, the triage/workflow routing computer 102 examines the electronic claim file to determine whether it is complete, in terms of including all components required for further processing. If not, the triage/workflow routing computer 102 routes the electronic claim file (step 406) to the computer of a suitable employee of the insurance company who is responsible for obtaining information necessary to complete the electronic claim file. Once that has been done, the electronic claim file may be routed back to the triage/workflow routing computer 102, as suggested by dashed arrow path 408, at which point steps 402 and 404 may be repeated.

If a positive determination is made at decision block 404 (i.e., if the triage/workflow routing computer 102 determines that the electronic file received at 402 was complete), then decision block 410 follows decision block 404. At decision block 410, the triage/workflow routing computer 102 determines whether the electronic claim file identifies the insurance carrier of at least one other vehicle involved in the accident with the vehicle insured by the insurance company that operates the triage/workflow routing computer 102. If such is not the case, then block 412 follows decision block 410. At 412, the triage/workflow routing computer 102 may route the electronic claim file to an insurance company employee in the claim recovery office who is responsible for investigating whether another insurance company is involved. (Alternatively, if the file definitively states that the other driver was uninsured, the triage/workflow routing computer 102 may route the claim file for handling by a collections operation that will seek recovery directly from the other driver.) To perform this investigation, the employee in question may contact the other driver/owner of the other vehicle to obtain information about insurance coverage on the other vehicle. If another carrier is identified by the investigation, the file may then be routed back (path 414) to the triage/workflow routing computer 102 with the other carrier information appended.

If a positive determination is made at decision block 410 (i.e., if the triage/workflow routing computer 102 determines that the other insurance company is identified in the electronic claim file), then decision block 416 follows decision block 410. At decision block 416, the triage/workflow routing computer 102 determines whether the electronic claim file contains complete contact information for the other insurance company. If not, then block 418 may follow decision block 416. At 418, the triage/workflow routing computer 102 may route the electronic claim file to an administrative employee who is to get in touch with the other insurance company in order to obtain the contact information needed for further processing of the claim. Once the necessary contact information is obtained for the other insurance company, the electronic claim file may be routed back (path 420) to the triage/workflow routing computer 102 with the other insurance company contact information appended.

If a positive determination is made at decision block 416 (i.e., if the triage/workflow routing computer 102 determines that the electronic claim file contains adequate contact information for the other insurance company), then decision block 422 follows decision block 416. At decision block 422, the triage/workflow routing computer 102 may determine whether the electronic claim file indicates that the other insurance company contests or is likely to contest liability for the claim. If the triage/workflow routing computer 102 determines at 422 that such is the case, then blocks 424 and 426 may follow decision block 422. The activities of the triage/workflow routing computer 102 at blocks 424 and 426 may be like those described above in connection with blocks 316 and 318 of FIG. 3. That is, the triage/workflow routing computer 102 may send a demand package concerning the claim to the other insurance company, and then may route the electronic claim file to a senior claim handler for prompt follow-up and negotiation with the other insurance company.

Alternatively, the triage/workflow routing computer 102 may determine at decision block 422 that the other insurance company does not, or is not likely to, contest liability. In some embodiments, this determination is made only in case of one or another of the three circumstances described above in connection with finding 310 in FIG. 3A. In such a case, decision block 428 (FIG. 4B) may follow decision block 422 (FIG. 4A). At decision block 428, the triage/workflow routing computer 102 may determine whether the electronic claim file indicates that the payment(s) made by the insurance company for the claim include payment for personal injury. If so, then blocks 430 and 432 (FIG. 4B) may follow decision block 428. At block 430, the triage/workflow routing computer 102 may send a demand package to the other insurance carrier in the manner described above. Then, at 432, the triage/workflow routing computer 102 may route the electronic claim file to an employee in the claim recovery office who specializes in negotiating personal injury payment claims with other insurance companies. The PIP (personal injury protection) specialist may follow-up promptly with the other insurance company (i.e., within a few days after the demand package likely was received by the other insurance company) to move the issues involved in the case toward resolution with reasonable dispatch.

If a negative determination is made at decision block 428 (i.e., if the triage/workflow routing computer 102 determines that the insurance company did not make payments for personal injury in connection with the claim), then block 434 may follow decision block 428. Block 434 may entail the triage/workflow routing computer 102 sending the demand package to the other insurance company and deferring further activity in the same manner described above in connection with block 320 in FIG. 3. Next, at block 436, the triage/workflow routing computer 102 may commence monitoring the payments received in the claim recovery office to determine (decision block 438) whether the insurance company receives payment from the other company with respect to the demand made at block 434. If at decision block 438 the triage/workflow routing computer 102 determines that a payment has been received for the claim file in question, then decision block 440 follows decision block 438. At decision block 440, the triage/workflow routing computer 102 determines whether the amount paid by the other insurance company matches the amount demanded. If so, then the triage/workflow routing computer 102 may close the file, as indicated at block 442. However, if the triage/workflow routing computer 102 determines at decision block 440 that the payment did not match the demand, then the process may advance from decision block 440 to block 444. At 444, the triage/workflow routing computer 102 may route the electronic claim file to a relatively junior claim handler so that the claim handler may contact the other insurance company to negotiate for further payment from the other insurance company.

Referring again to decision block 438, if the triage/workflow routing computer 102 makes a negative determination at that point (i.e., if no payment has been received), then the process advances from decision block 438 to decision block 446. At decision block 446, the triage/workflow routing computer 102 determines whether the period for deferral of activity, as set in block 434 (cf. block 320, FIG. 3), has elapsed. If not, then the process loops through decision blocks 438 and 446 until either payment is received on the file or the deferral period runs out. However, if at decision block 446 the triage/workflow routing computer 102 determines that the deferral period has elapsed, then the process may advance from decision block 446 to block 448. At block 448, the triage/workflow routing computer 102 may route the electronic file to a suitable employee in the claim recovery office. This employee may, for example, be an administrative employee who may contact the other insurance company (as in block 328, FIG. 3) to ascertain why the other insurance company has not yet paid the demand. As before, the administrative employee may forward the claim file to an experienced claim handler if it turns out that the other insurance company is contesting liability. Alternatively, if it appears that the obstacles to payment from the other insurance company are largely administrative, the administrative employee of the demanding insurance company may continue to follow up with the other insurance company until payment is received.

In the example embodiments described above, the triage and workflow routing functions are largely automated. However, in alternative embodiments, significant aspects of these functions may be handled by human employees rather than by computer. Details of such less-automated embodiments will now be described.

Initially, in such embodiments the claim file may be received in hard-copy form by a back-office portion of the insurance company's claim recovery office. The back-office operation may check the file for completeness and may correct any deficiencies in that respect. The back office operation may also enter the claim file in the claim recovery office's docket system, sort the claim file by “line of business” (type of policy), and then perform a triage decision under which the file is placed into one of the following four categories: (1) The other vehicle is uninsured; (2) the other vehicle is insured and the other insurance carrier admits or is likely to admit liability; (3) the other vehicle is insured and the other insurance carrier does not admit and is not likely to admit liability; (4) it is not known if the other vehicle is insured.

The back office may route the file based on the category to which the file is assigned. In the case of files in category (1), the file may be routed to a demand administration team for forwarding to a department or office of the insurance company which specializes in collection of amounts from individuals. If the file has been classified in category (4), the file may be routed to the demand administration team for the purpose of contacting the other driver/other car owner (hereinafter the “responsible party” or “RP”). For files in this category the demand administration team may attempt several times to reach the responsible party. If successful, the demand administration team determines whether or not the responsible party is insured. If not, the demand administration team may forward the file to the department or office of the insurance company which specializes in collection of amounts from individuals.

If it turns out the responsible party is insured, then the case may be recategorized as either category (2) or category (3), depending on the nature of the accident in question.

With respect to the original or later selection between the categories (2) and (3), it may be preferred, as noted above in connection with block 320 (FIG. 3), that category (2) be selected for the file if and only if the other insurance company has either explicitly admitted liability, or the insured vehicle was rear-ended or struck while parked.

For files assigned to category (2), the demand administration team may prepare and send out to the other insurance company a demand package, such as those referred to above in connection with FIGS. 3 and 4A-4B. Preliminary to doing so, the demand administration team may contact the other insurance company to obtain contact information such as the address, e-mail address and/or fax phone number for the other insurance company. In addition, in the initial contact, the demand administration team may attempt to learn the position of the other insurance company with respect to liability for the claim. If necessary in view of the latter, the file may be recategorized from category (2) to category (3). The demand administration team may also determine whether the claim involved payments for personal injury. If so, the demand administration team may forward the file to a senior claim handling team for handling as described below.

If the file remains in category (2) and did not involve payment for personal injury, then the demand administration team may defer further activity to await anticipated payment of the demand by the other insurance company. As noted above, a preferred deferral period may last 43 days. If payment of the demand in full is received within that time, the case may be closed. If payment in full is not received within that time, then the demand administration team may route the file to a junior claim handling team.

The junior claim handling team may first determine again whether there has been payment for personal injury and if so may forward the file to the senior claim handling team. If not, the junior claim handling team may contact the other insurance company by telephone to inquire about the status of the demand. As part of that contact, the junior claim handling team may also learn what is the position of the other insurance company with respect to liability. If the other insurance company requests further documentation, the junior claim handling team may supply the same to the other insurance company. If appropriate, the junior claim handling team may negotiate with the other insurance company with respect to the amount of damages that was the subject of the demand. If the other insurance company insurance company accepts liability in full or agreement is reached through negotiation as to a lower amount of damages, the junior claim handling team may diary the case for further follow-up until the payment is received. If the other insurance company contests liability or agreement cannot be reached on the amount of damages, then the junior claim handling team may route the file to the senior claim handling team.

The senior claim handling team may receive the claim file from the demand administration team, the junior claim handling team or the back-office staff. Upon receiving the file, the senior claim handling team assigns the file to a claim handler within the senior claim handling team. The assigned claim handler reviews the file and makes a telephone call to the other insurance company to negotiate a settlement of the demand. If a settlement is reached, the senior claim handling team diaries the file for follow-up until the agreed-upon payment is received. If any further issues arise, further negotiations may take place.

If the senior claim handling team is unable to reach a settlement with the other insurance company, the senior claim handling team decides whether to close the file without recovery or to pursue an arbitration case against the other insurance company. Any decision to close the file without recovery may be reviewed by the leader of the senior claim handling team. If a decision is made to pursue arbitration, then the claim file may be routed to a team in the claim recovery office that handles arbitrations. In some cases, however, the other insurance company may not be one that has agreed to arbitrate subrogation disputes. In those cases, the senior claim handling team may retain an attorney to bring litigation against the other insurance company if the senior claim handling team decides not to close the file.

In cases where the claim file involves payments for personal injury, the file may be assigned to a claim handler within the senior claim handling team who specializes in personal injury cases. The claim handler may handle the case in essentially the same manner described above with respect to the activities of the claim handler in the senior claim handling team.

Up to this point, the invention has been described within the context of recovery of payments with respect to claims under a motor vehicle policy. However, the principles of the present invention may also be applied to recovery of other types of payments, including for example payments for damage to buildings.

The process descriptions and flow charts contained herein should not be considered to imply a fixed order for performing process steps. Rather, process steps may be performed in any order that is practicable.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
receiving in a computer an electronic file that represents a claim paid by an insurance company, the electronic file containing indicia as to whether (a) said claim involves another insurance company and (b) said other insurance company has admitted or is likely to admit liability for said claim; and
making a triage decision in said computer such that:
(i) if said indicia indicate that another insurance company is involved and has admitted or is likely to admit liability for said claim, said computer generates a demand letter to said other insurance company with respect to said claim and defers further action relating to said demand for at least 20 days after generating said demand letter; and
(ii) if said indicia either do not indicate that another insurance company is involved or indicate that the other insurance company has not admitted or is not likely to admit liability for said claim, said computer generates a demand letter to said other insurance company and routes the electronic file to an employee for further action.

2. The method of claim 1, wherein if said indicia indicate that another insurance company is involved and has admitted or is likely to admit liability for said claim, said computer defers further action relating to said demand for at least 30 days after sending said demand letter.

3. The method of claim 2, wherein if said indicia indicate that another insurance company is involved and has admitted or is likely to admit liability for said claim, said computer defers further action relating to said demand for at least 40 days after sending said demand letter.

4. The method of claim 3, wherein if said indicia indicate that another insurance company is involved and has admitted or is likely to admit liability for said claim, said computer defers further action relating to said demand for 43 days after sending said demand letter.

5. The method of claim 1, wherein said computer prompts said employee to make a follow-up telephone call to said other insurance company within 10 days after said demand letter is sent.

6. The method of claim 1, wherein said paid claim relates to property damage to a motor vehicle.

7. The method of claim 6, wherein, if said indicia indicate said property damage was caused by an uninsured vehicle, said employee is a collection specialist.

8. The method of claim 6, wherein said employee is a claim handler if said indicia indicate that another insurance company is involved and has not admitted and is not likely to admit liability for said claim.

9. The method of claim 6, wherein said computer determines that said indicia indicate said other insurance company is likely to admit liability if said motor vehicle was parked at the time said damage occurred or was rear-ended.

10. The method of claim 9, wherein said indicia include a color-code applied to the electronic file by an employee of the insurance company that paid the claim.

11. The method of claim 1, wherein said paid claim relates to property damage to a building.

12. The method of claim 1, wherein said computer transmits said generated letter to the another insurance company.

13. The method of claim 12, wherein the transmitted letter has attachments thereto, the method further comprising said computer automatically obtaining at least one of said attachments.

14. The method of claim 13, wherein said attachments include at least one of: (a) a police report; (b) at least one color photograph of a damaged vehicle; (c) at least one color photograph of a motor vehicle accident scene; (d) a payment ledger; (e) a vehicle damage appraisal; and (f) a replacement vehicle rental bill.

15. An apparatus comprising:
a processor; and
a memory in communication with said processor and storing program instructions, the processor operative with said program instructions to:
receive an electronic file that represents a claim paid by an insurance company, the electronic file containing indicia as to whether (a) said claim involves another insurance company and (b) said other insurance company has admitted or is likely to admit liability for said claim; and
make a triage decision such that:
(i) if said indicia indicate that another insurance company is involved and has admitted or is likely to admit liability for said claim, said processor sends out a demand letter to said other insurance company with respect to said claim and defers further action relating to said demand for at least 20 days after said demand letter is sent; and
(ii) if said indicia either do not indicate that another insurance company is involved or indicate that the other insurance company has not admitted or is not likely to admit liability for said claim, said processor sends out a demand letter to said other insurance company and routes the electronic file to an employee for further action.

16. The apparatus of claim 15, wherein if said indicia indicate that another insurance company is involved and has admitted or is likely to admit liability for said claim, said processor defers further action relating to said demand for at least 30 days after said demand letter is sent.

17. The apparatus of claim 16, wherein if said indicia indicate that another insurance company is involved and has admitted or is likely to admit liability for said claim, said processor defers further action relating to said demand for at least 40 days after said demand letter is sent.

18. The apparatus of claim 17, wherein if said indicia indicate that another insurance company is involved and has admitted or is likely to admit liability for said claim, said processor defers further action relating to said demand for 43 days after said demand letter is sent.

19. The apparatus of claim 15, wherein said processor prompts said employee to make a follow-up telephone call to said other insurance company within 10 days after said demand letter is sent.

20. The apparatus of claim 15, wherein said paid claim relates to property damage to a motor vehicle.

21. The apparatus of claim 20, wherein, if said indicia indicate said property damage was caused by an uninsured vehicle, said employee is a collection specialist.

22. The apparatus of claim 20, wherein said employee is a claim handler if said indicia indicate that another insurance company is involved and has not admitted and is not likely to admit liability for said claim.

23. The apparatus of claim 20, wherein said processor determines that said indicia indicate said other insurance company is likely to admit liability if said motor vehicle was parked at the time said damage occurred or was rear-ended.

24. The apparatus of claim 15, wherein said paid claim relates to property damage to a building.

25. An article of manufacture comprising:
a computer usable medium having computer readable program code means embodied therein for making a triage decision with respect to a paid insurance claim, the computer readable program code means in said article of manufacture comprising:
computer readable program code means for causing a computer to receive an electronic file that represents said claim, said claim having been paid by an insurance company, the electronic file containing indicia as to whether (a) said claim involves another insurance company and (b) said other insurance company has admitted or is likely to admit liability for said claim; and
computer readable program code means for causing said computer to make a triage decision such that:
(i) if said indicia indicate that another insurance company is involved and has admitted or is likely to admit liability for said claim, said computer sends out a demand letter to said other insurance company with respect to said claim and defers further action relating to said demand for at least 20 days after said demand letter is sent; and
(ii) if said indicia either do not indicate that another insurance company is involved or indicate that the other insurance company has not admitted or is not likely to admit liability for said claim, said computer sends out a demand letter to said other insurance company and routes the electronic file to an employee for further action.

26. A method comprising:
receiving in a computer an electronic file that represents a claim paid by an insurance company, the electronic file containing indicia as to whether (a) said claim involves another insurance company and (b) said other insurance company has admitted or is likely to admit liability for said claim; and
making a triage decision in said computer such that:
(i) if said indicia indicate that another insurance company is involved and has admitted or is likely to admit liability for said claim, said computer generates a demand letter to said other insurance company with respect to said claim and defers further action relating to said demand for a predetermined period after generating said demand letter; and
(ii) if said indicia either do not indicate that another insurance company is involved or indicate that the other insurance company has not admitted or is not likely to admit liability for said claim, said computer generates a demand letter to said other insurance company and routes the electronic file to an employee for further action.

27. The method of claim 26, wherein said predetermined period is at least 20 days.

28. The method of claim 27, wherein said predetermined period is at least 30 days.

29. The method of claim 28, wherein said predetermined period is 43 days.
